(19) United States
(12) Patent Application Publication
(10) Pub. No.: US 2025/0335980 A1
(43) Pub. Date: Oct. 30, 2025

(54) BANK TRANSACTION RECORDING SYSTEM AND COMPUTER-IMPLEMENTED METHOD THEREOF

(71) Applicant: Sung Hiu Kwong, Tuen Mun (HK)

(72) Inventor: Sung Hiu Kwong, Tuen Mun (HK)

(21) Appl. No.: 18/524,045

(22) Filed: Apr. 25, 2024

(51) Int. Cl. G06Q 40/02

(52) U.S. Cl. CPC G06Q 40/02

(57) ABSTRACT

The invention relates to the field of accounting data processing, a bank transaction recording method, a bank reconciliation method and an auto accounting entry mechanism thereof, which introduce a comprehensive system and method for revolutionizing the recording and management of bank transactions, with a particular focus on streamlining accounting processes. The invention consists of three interrelated embodiments as set forth in the summary of the patent application, each contributing unique and invaluable functionalities to enhance efficiency, accuracy, and automation in financial record-keeping.

### TECHNICAL FIELD

The application relates to the field of accounting data processing, in particular to a bank transaction recording method, a bank reconciliation method and an auto accounting entry mechanism thereof.

### BACKGROUND

Double-entry bookkeeping is a bookkeeping method, which takes the balance between assets and equity as the basis for the bookkeeping and registers each economic business in two or more interconnected accounts at an equal amount. This can systematically reflect the results of changes in capital movement. The operation idea of the double-entry bookkeeping is that if there is borrowing, there must be lending, and borrowing and lending must be equal.

The double-entry bookkeeping is characterized by its ability to reflect the source and whereabouts of funds, as well as changes in assets and equity, so as to maintain a loan balance. It can improve the accuracy and completeness of bookkeeping, facilitate the inspection and verification of accounts, and facilitate the analysis and control of business conditions. Therefore, in the prior art, the majority of businesses worldwide employ the double-entry method for conducting their accounting operations.

Nonetheless, it is important to acknowledge that double-entry bookkeeping comes with its intricacies and limitations. This method requires personnel responsible for data entry to possess a robust understanding of specific accounting principles and skills, which can lead to relatively slower efficiency in the bookkeeping process.

### SUMMARY

In order to solve or at least partially solve the above technical problems, the present application can provide a detailed description of an application for recording and managing bank transactions using a double-entry accounting method. Here is a summary of the key features and functionalities mentioned in the first embodiment of the invention:
Single Row Double-Entry: The application utilizes a double-entry accounting format to record bank transactions. Each transaction is recorded with elements such as date, accounts involved, currency, credited and debited amounts, a balanced debit side, a balanced credit side, and a description.
Bank Transaction Table Entry Platform: A table format (Table 4) is used to input bank transactions, which simplifies data entry. It includes fields for date, bank account, currency, debit or credit amount, the other account or customer, and a description. Debit and credit columns are not included since they are specific to bank transactions. The system automatically generates a voucher in the double-entry format from this input.
Multiple Transactions Input: The application supports the input of multiple transactions simultaneously in a table format (Table 4). Users can input data for multiple transactions from the same day and copy/paste it vertically, streamlining data entry.
Automatic Voucher Generation: When users save the data in Table 4, the system automatically records the individual transactions as standard double-entry vouchers (Table 5). The system can also categorize voucher numbers as receipt or payment vouchers.
Efficiency in Data Input: This method simplifies data input by allowing users to enter transactions vertically, resembling a “fill-in-the-blank” approach. It primarily focuses on bank transactions, particularly deposits and withdrawals.
Invoice Settlements: The application handles receipt and payment vouchers and can distinguish between account names and customer names. When a customer's name is entered, the system provides notifications of outstanding invoices related to that specific customer.
Balancing Transactions: If the bank deposit amount matches the selected invoices' total, the system records the transaction in the double-entry format. If there's not perfect matched, a ‘settle’ icon appears, indicating the need to address the settlement.
Detailed View for Discrepancies: Clicking on the ‘settle’ icon leads to a detailed view (Table 9) that displays comprehensive information about the bank receipt and the selected invoice.
Adjustment of Payments: Users can make adjustments to payments if needed. For example, if a payment is partial, the system adjusts the outstanding balance accordingly (Table 10).

Overall, the application streamlines the process of recording and managing bank transactions, enhances efficiency in data entry, and provides features for handling invoice settlements and discrepancies, making it a valuable tool for accounting purposes.

The second embodiment of the invention introduces two main platforms: the Bank Transaction Table Entry Platform (BTEP) and the Bank Feed Platform (BFP). BTEP focuses on recording bank transactions, particularly deposits and withdrawals, in a tabular format resembling a bank statement. BFP, on the other hand, supports bank feed functionalities, enabling the import of bank transactions for reconciliation and offering features such as generating reports for unpresented checks and potentially automating accounting entries.

The heart of the innovation lies in automating bank reconciliation, a traditionally manual and error-prone process. The reconciliation process involves matching transactions based on similar amounts and proximity of dates, with matched transactions labeled with a date complement. Users can review and adjust pairings for accuracy and save correctly matched transactions.

The reconciliation process is initiated using buttons like “Match-Run,” “Match-Save,” “Match Y/N,” and “Create & Return.” These buttons streamline the reconciliation process, which comprises matching transactions, editing reconciled transactions, adding unreconciled transactions, and generating an unpresented check report.

A Reconciliation Platform, illustrated in Table 13, visually represents the reconciliation process. The initiation of reconciliation involves clicking the “Match-Run” button, which opens a Reconciliation window displaying matching results. Reconciled transactions are marked by mirroring dates between BTEP and BFP, while unreconciled transactions remain blank.

Users can also manually reconcile transactions by selecting and pairing them individually, ensuring correctness. Correctly paired transactions can be saved by clicking the “Match-Save” button.

For unreconciled transactions in BFP, users can create new transactions in BTEP based on these unreconciled entries. The system auto-fills some information, streamlining data entry. This process ensures a complete record and facilitates bank reconciliation.

Unreconciled transactions in BTEP are identified as unpresented transactions and can be addressed in future reconciliation attempts. Additionally, the Feed Start Date and Balance information in BFP helps verify the correctness of bank feed and reconciliation processes. The Period Start Date controls the display of transactions in BTEP, improving flexibility in applying bank feed and reconciliation functions at any time during the accounting period.

Overall, this embodiment simplifies bank transaction recording and automates reconciliation, making it more efficient, accurate, and user-friendly. It also provides tools to identify and address unreconciled transactions and offers a flexible approach to applying these functions in accounting processes.

The third embodiment introduces an “Auto Accounting Entry” feature that builds upon the Bank Transaction Table Entry Platform (BTEP) and its extended feature, the Bank Feed Platform (BFP). BFP incorporates a scheduled automatic bank transaction import function, and when it includes payer/payee information, machine learning is used to automatically assign them to the appropriate account. This enables the automation of the accounting process, achieving “Auto Accounting Entry.”

When bank transaction data is imported through the bank feed, it resembles a bank statement, including details like date, amount, income or expense categorization, and currency. Some statements contain payer/payee information, while others do not. When payer/payee data is available, it populates the “customer/account” column during the addition of a bank transaction, and machine learning matches this information with the correct account.

This automation is applied to formalize admin expenses into official admin vouchers and facilitate customer and supplier settle vouchers. The goal is to complete the payment or receipt voucher portion while keeping the settlement of invoice portion for later processing.

With this mechanism, bank transactions can be automatically converted into completed vouchers without manual intervention. The user's role is to confirm transaction correctness and supplement invoice numbers by pressing the ‘settle’ button, thus requiring minimal user input.

This automated accounting function has the potential to eliminate the need for pre-creating accounting entries, allowing the bank feed to bring in transaction data, and using the ‘auto create’ feature to automatically complete the accounting process. It simplifies accounting, reduces the need for accounting knowledge, and enhances efficiency in accounting processes.

According to the first embodiment of the invention:

The system unveils a groundbreaking “Single Row Double-Entry” approach to bank transaction recording. Utilizing a specialized table entry platform, users input transaction data effortlessly, including date, accounts, currency, amounts, and descriptions. The innovation lies in the table header, which facilitates precise data input and auto-generates standard double-entry vouchers, simplifying daily accounting processes. The system's ability to distinguish between deposits and withdrawals further enhances its utility.

According to the second embodiment of the invention:

Building upon the first embodiment, the system introduces two key platforms: the Bank Transaction Table Entry Platform (BTEP) and the Bank Feed Platform (BFP). BTEP provides a user-friendly table format for recording bank transactions, while BFP revolutionizes bank reconciliation with automated matching and pairing of transactions. Users can streamline the reconciliation process, identify and reconcile unpresented checks, and maintain a visual representation of reconciliation progress.

According to the third embodiment of the invention:

Incorporating the capabilities of BTEP and BFP, the third embodiment introduces an “Auto Accounting Entry” feature. This feature leverages machine learning to automate the assignment of payer/payee information to the appropriate accounts, effectively automating the accounting process. Users can confirm transaction correctness and supplement invoice details, transforming bank transactions into completed vouchers with minimal manual intervention. This automation streamlines accounting, reduces the need for accounting expertise, and significantly enhances efficiency.

### BRIEF DESCRIPTION OF THE DRAWINGS

In order to more clearly explain the embodiment of the present application, the relevant accompanying drawings will be briefly introduced below. It is understood that the accompanying drawings in the following description are only used to illustrate some embodiments of the present application, and those skilled in the art can also obtain many other technical features and connections not mentioned in the present application from these drawings.

FIG. 1 is a flow chart of a bank transaction recording method provided by the present application.

FIG. 2 is a structural diagram of a bank reconciliation system provided by the present application.

FIG. 3 includes Table 22 discussed herein.

FIG. 4 includes Table 23 discussed herein.

### DETAILED DESCRIPTION

The technical scheme in the embodiments of the application will be described in detail below in combination with the accompanying drawings in the embodiments of the application.

Before introducing the present application, the related art involved in the present application will be described first.

### Double-Entry Bookkeeping

Table 1 shows the standard double-entry format of a bank withdrawal transaction:

TABLE 1

| Date | Accounts | Hkd | Hkd | Description |
|---|---|---|---|---|
| 2022 Jan. 1 | DEF co ltd | 350 | | payment of |
| 2022 Jan. 1 | Bank current account | | 350 | vendor invoice |

The voucher has various parts: the date, the first account (DEF co ltd), the second account (bank current account), the currency, the credited and debited amounts, a debit side, a credit side (which always balance), and a description. These details fully describe the transaction information.

In this example, it's clear that traditional double-entry bookkeeping has a certain limitation. Splitting the same transaction into two rows makes it hard to intuitively link them. Plus, there's a lot of repetitive data, increasing redundancy in the data tables, taking up more database space, and slowing down efficiency. This isn't ideal for computer data processing.

To address these issues, this application introduces a novel bank transaction recording method, offering a fresh solution to these technical challenges.

### First Embodiment

The initial embodiment of this application introduces a bank transaction recording method.

### Single Row Double-Entry

Table 1 above illustrates the standard double-entry format for a bank withdrawal transaction.

The voucher encompasses the following elements: date, the first account (DEF co ltd), the second account (bank current account), currency, the credited and debited amounts, a balanced debit side, a balanced credit side, and a description. These details collectively provide comprehensive information about the transaction.

TABLE 2
bank transaction table entry platform

| | | | | | | | | | |
|---|---|---|---|---|---|---|---|---|---|
| SAVE | | | | | | | account/ | | |
| date | bank | cur | deposit | withdrawal | ex. Rate | amount | customer | invoice | description |

| | | | | | | | | |
|---|---|---|---|---|---|---|---|---|
| 1 | 2022 Jan. 1 | c/a | hkd | 350 | 1 | 350 | DEF co ltd | payment to |
| | | | | | | | | DEF |
| 2 | | | | | | | | |
| 3 | | | | | | | | |

Table 2 presents the ‘Bank Transaction Table Entry Platform.’ The table header contains nearly identical components to those found in the previously mentioned voucher illustrated in Table 1, such as date, bank account, currency, amount for debit or credit, the other account (account/customer), and description. It's worth noting that the debit and credit columns are absent in this platform since they are exclusive to bank transactions. Furthermore, only one field between the ‘deposit’ and ‘withdrawal’ columns can be filled, effectively eliminating the need for a separate debit or credit column.

Once the data is input as demonstrated in Table 2, a voucher is automatically generated in the standard double-entry format, as depicted in Table 3.

TABLE 3

| | Voucher | | | | | | | | local | | |
|---|---|---|---|---|---|---|---|---|---|---|---|
| | voucher# | date | account | a/c code | cur | dr | Cr | ex. rate | amount | invoice | description |
| 1 | P- | 2022 Jan. 1 | DEF Ltd | c-300741 | hkd | 350 | | 1 | 350 | | payment to |
| | 22010001 | | | | | | | | | | DEF |
| 2 | P- | 2022 Jan. 1 | bank c/a | c-202001 | hkd | | 350 | 1 | 350 | | payment to |
| | 22010001 | | | | | | | | | | DEF |

### Bank Transaction Table Entry

As depicted in Table 4, the system also facilitates the simultaneous input of multiple transactions through a table format. This can be viewed as an extension of the single-row double-entry format, effectively constituting the table entry platform.

For instance, if you have multiple transactions from the same day, you can input the data once and then simply copy and paste it vertically, all conveniently managed in one place.

TABLE 4
bank transaction table entry platform

| | | | | | NEW | | | | | |
|---|---|---|---|---|---|---|---|---|---|---|
| | SAVE | | | bank+ | bank− | | | account/ | | |
| | date | bank | cur | deposit | withdrawal | ex. rate | amount | customer | invoice | description |
| 1 | 2022 Jan. 1 | c/a | hkd | | 350 | 1 | 350 | DEF co Ltd | | payment to |
| | | | | | | | | | | DEF |
| 2 | 2022 Jan. 3 | c/a | hkd | | 600 | 1 | 600 | electricity | | payment |
| | | | | | | | | | | for dec |
| 3 | 2022 Jan. 15 | c/a | hkd | 1500 | | 1 | 1500 | ABC Ltd | inv- | payment fr |
| | | | | | | | | | 84321 | ABC |
| 4 | 2022 Jan. 24 | c/a | hkd | | 430 | 1 | 430 | courier | | payment |
| | | | | | | | | | | UK parcel |
| 5 | | | | | | | | | | |
| 6 | | | | | | | | | | |
| 7 | | | | | | | | | | |
| 8 | | | | | | | | | | |

Rows #1 to #4 in the table represent four distinct bank transactions. In the “bank deposit” column, only row #3 is filled, signifying that it pertains to a receipt transaction. Conversely, the “bank withdrawal” column is filled for all rows (#1, #2, and #3), indicating that these transactions involve bank payments. The content of each transaction can be easily cross-referenced with the respective column in the table header.

Upon saving, the system records these four single-row transactions displayed in Table 4 as four standard double-entry vouchers, as demonstrated in Table 5. Additionally, the system can automatically categorize the prefix of voucher numbers as either receipt or payment vouchers.

TABLE 5

| | Voucher | | | | | | | ex. | local | | |
|---|---|---|---|---|---|---|---|---|---|---|---|
| | voucher # | date | account | a/c code | cur | dr | er | rate | amount | invoice | description |
| 1 | P- | 2022 Jan. 1 | DEF Ltd | c-300741 | hkd | 350 | | 1 | 350 | | payment |
| | 22010001 | | | | | | | | | | to DEF |
| 2 | P- | 2022 Jan. 1 | bank c/a | c-202001 | hkd | | 350 | 1 | 350 | | payment |
| | 22010001 | | | | | | | | | | to DEF |
| 3 | P- | 2022 Jan. 3 | electricity | c-660531 | hkd | 600 | | 1 | 600 | | payment |
| | 22010002 | | | | | | | | | | for dec |
| 4 | P- | 2022 Jan. 3 | bank c/a | c-202001 | hkd | | 600 | 1 | 600 | | payment |
| | 22010002 | | | | | | | | | | for dec |
| 5 | R- | 2022 Jan. 15 | bank c/a | c-202001 | hkd | 1500 | | 1 | 1500 | inv- | receipt fr |
| | 22010001 | | | | | | | | | 84321 | ABC |
| 6 | R- | 2022 Jan. 15 | ABC Ltd | c-300823 | hkd | | 1500 | 1 | 1500 | inv- | receipt fr |
| | 22010001 | | | | | | | | | 84321 | ABC |
| 7 | P- | 2022 Jan. 24 | courier | c-660741 | \|hkd | 430 | | 1 | 430 | | payment |
| | 22010003 | | | | | | | | | | UK parcel |
| 8 | P- | 2022 Jan. 24 | bank c/a | c-202001 | hkd | | 430 | 1 | 430 | | payment |
| | 22010003 | | | | | | | | | | UK parcel |

Therefore, daily bank transactions, whether they involve deposits or withdrawals, can be entered in a single table, simplifying and accelerating daily accounting processes.

The table entry platform offers distinct features compared to typical accounting entry methods. Instead of the conventional method of inputting transactions horizontally from one column to another, you can input them vertically or even copy and paste them within the same column using a table format, as demonstrated in Table 4.

This method simplifies data input, adopting like a “fill-in-the-blank” approach, with a primary emphasis on bank transactions, specifically encompassing deposits and withdrawals. The presented table replicates the structure of a bank statement and is poised to serve as the foundation for forthcoming developments in the field of intelligent accounting.

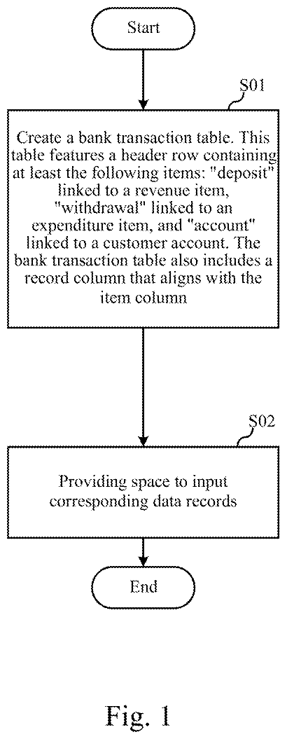

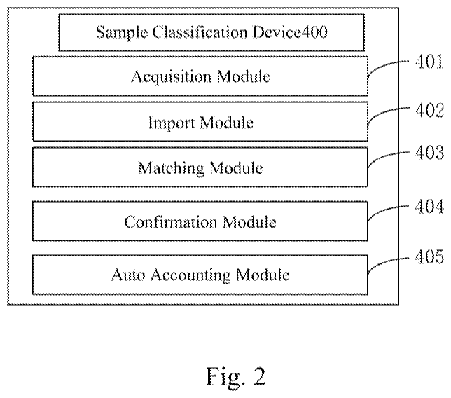

As illustrated in FIG. 1 and FIG. 2. This method involves the following steps:
Step 1 (S01): Create a bank transaction table. This table features a header row containing at least the following items: “deposit” linked to a revenue item, “withdrawal” linked to an expenditure item, and “account” linked to a customer account. The bank transaction table also includes a record column that aligns with the item column, and
Step 2 (S02) providing space to input corresponding data records.

As an alternative illustration, the item column can include additional items, either individually or in combination, such as:
“Voucher number,” linked to the transaction's identification number.
“Date,” associated with the transaction's date.
“Cur,” connected to the transaction's currency.
“Ex. rate,” related to the exchange rate.
“Invoice,” tied to the transaction's invoice number.

Table 6 below offers a typical example of the bank transaction table in this application:

TABLE 6
bank transaction table entry platform

| | | | | | NEW | | | | | |
|---|---|---|---|---|---|---|---|---|---|---|
| | SAVE | | | bank+ | bank− | ex. | | account/ | | |
| | date | bank | cur | deposit | withdrawal | rate | amount | customer | invoice | description |
| 1 | 2022 Jan. 1 | c/a | hkd | | 350 | 1 | 350 | DEF co Ltd | | payment to |
| | | | | | | | | | | DEF |
| 2 | 2022 Jan. 3 | c/a | hkd | | 600 | 1 | 600 | electricity | | payment to dec |
| 3 | 2022 Jan. 15 | c/a | hkd | 1500 | | 1 | 1500 | ABC Ltd | inv- | |
| | | | | | | | | | #84321 | |
| 4 | | | | | | | | | | |
| 5 | | | | | | | | | | |

A significant concern when dealing with receipt and payment vouchers revolves around invoice settlements.

Take the third transaction, dated Jan. 15, 2022, with an amount of $1,500, as shown in Table 6, as an example. This transaction represents a bank deposit from the customer ‘ABC Ltd’ for settling invoice #84321. When we input a customer's name in the ‘account/customer’ column, the system can differentiate between account names and customer names. It then displays a notification listing all outstanding invoices related to that specific customer as illustrated in Table 7.

TABLE 7

| | | confirm | cancel | | | | | local | | |
|---|---|---|---|---|---|---|---|---|---|---|
| | □ | customer | inv/cos | date | cur | amount | ex. rate | amount | outstanding | description |
| 1 | □ | ABC ltd | inv-#84321 | 2022 Jan. 08 | hkd | 1500 | 1 | 1500 | 1500 | goods |
| | | | | | | | | | | purchase |
| 2 | □ | ABC ltd | inv-#84423 | 2022 Jan. 11 | hkd | 2200 | 1 | 2200 | 2200 | goods |
| | | | | | | | | | | purchase |
| 3 | □ | ABC ltd | inv-#84488 | 2022 Jan. 30 | hkd | 1830 | 1 | 1830 | 1830 | goods |
| | | | | | | | | | | purchase |
| 4 | □ | ABC ltd | inv-#84507 | 2022 Jan. 04 | hkd | 2650 | 1 | 2650 | 2650 | goods |
| | | | | | | | | | | purchase |
| 5 | □ | | | | | | | | | |

If the amount entered in the bank deposit aligns perfectly with the total of selected invoices, it signifies that the invoices are balanced, and the settlement has been completed. The system records this in the standard double-entry format.

However, if for any reason the amounts do not match precisely, a ‘settle’ icon appears in the voucher list after saving as demonstrated in Table 8, serving as a reminder to either address the discrepancy immediately or at a later time.

TABLE 8

| | | | | | | | | | | |
|---|---|---|---|---|---|---|---|---|---|---|
| | Bank | | | | | | | | | |
| | List | | | | | | | | | |
| □ | voucher | type | date | cur | dr | cr | ex. | amount | accum | description |

| | | | | | | | | | | | |
|---|---|---|---|---|---|---|---|---|---|---|---|
| | | | | | | | rate | | bal | | |
| 1 | □ | | | | | | | | | | |
| 2 | □ | R- | B | 2022 Jan. 15 | hkd | 1500 | 1 | 1500 | | receipt fr | settle |
| | | 22010001 | | | | | | | | ABC | |
| 3 | □ | | | | | | | | | | |

Referring to the earlier example of the HKD1500 receipt, if it represents a payment towards invoice #84423, totaling HKD2200, it results in an outstanding balance of HKD700 in red. This unaccounted balance renders the account unbalanced, triggering a ‘settle’ notification, as demonstrated in Table 8.

Clicking on the ‘settle’ icon leads to a new page displaying comprehensive details of the bank receipt and the selected invoice as demonstrated in Table 9.

TABLE 9

| | | | | | | | | | | |
|---|---|---|---|---|---|---|---|---|---|---|
| | save | delete | | settle | ex. | | | local | | |
| delete | date | account | inv/cos | cur | rate | dr | cr | amount | outstanding | description |

| | | | | | | | | | | |
|---|---|---|---|---|---|---|---|---|---|---|
| 1 | □ | 2022 Jan. 15 | bank | | hkd | 1 | 1500 | | 1500 | receipt fr |
| | | | c/a | | | | | | | ABC |
| 2 | □ | 2022 Jan. 15 | ABC | inv- | hkd | 1 | | 2200 | 2200 | |
| | | | ltd | #84423 | | | | | | |
| 3 | □ | | | | | | | | | |
| 4 | □ | | | | | | | | | |
| 5 | □ | | | | | | | | | |
| 6 | □ | | | | | | | | | |
| 100 | | | | | | total | 1500 | 2200 | −700 | |

TABLE 10

| | | save | delete | inv / | settle | ex. | | | local | | |
|---|---|---|---|---|---|---|---|---|---|---|---|
| | delete | date | account | cos | cur | rate | dr | cr | amount | outstanding | description |
| 1 | □ | 2022 Jan. 15 | bank | | hkd | 1 | 1500 | | 1500 | | receipt fr |
| | | | c/a | | | | | | | | ABC |
| 2 | □ | 2022 Jan. 15 | ABC | inv- | hkd | 1 | | 1500 | 1500 | 700 | |
| | | | ltd | #84423 | | | | | | | |
| 3 | □ | | | | | | | | | | |
| 4 | □ | | | | | | | | | | |
| 5 | □ | | | | | | | | | | |
| 6 | □ | | | | | | | | | | |
| 100 | | | | | | total | 1500 | 1500 | 0 | | |

When considering the transaction as a partial payment towards invoice #84423, the amount is adjusted from HKD2200 to HKD1500, resulting in a credit of HKD1500. This change leaves HKD700 in the outstanding column, as depicted in Table 10.

Table 10 illustrates this adjustment, where the previously outstanding HKD700 in red has been reconciled, and invoice #84423 now shows a pending balance of HKD700, awaiting the next payment.

It's important to note that as an alternative, the method may incorporate the following steps:

Assessing the data filling status in the record column for both the deposit and withdrawal items within the same row, If one of the two fields has been filled, the other field will be automatically locked to prevent the entry of incorrect data into the record column with corresponding information, thereby reducing the likelihood of errors.

In a broader context, there are two categories of vouchers that record different types of transactions. Firstly, there are receipt and payment vouchers, which document “deposits” and “withdrawals” of bank and cash, respectively. Secondly, revenue and cost vouchers deal with “invoices” and “bills and expenditures,” respectively.

The transaction data for the first type of vouchers is facilitated by the innovative features of the “bank transaction table entry platform.” Similarly, for the second type of vouchers, a similar table entry platform can be customized specifically for invoices and bills.

“Deposit” and “Withdrawal” transactions are labeled as “receipt vouchers” and “payment vouchers,” respectively, with voucher numbers automatically allocated and categorized using distinct prefixes based on their respective categories.

Through the aforementioned technical solution, the current application boasts the following characteristics and technical advantages:

This single-row double-entry approach, utilizing a data entry table that consolidates all voucher components into the header row, following this sequence:

/date/bank/currency/bank deposit/bank withdrawal/exchange
rate/amount/account/customer/invoice/description.

The corresponding data is then populated within this table. Upon saving, a voucher is automatically generated and recorded in the conventional double-entry format.

Considering that a single row of data can represent a transaction and be recorded as a standard double-entry voucher, envision a table with numerous rows and columns where multiple transactional data entries can be filled in and saved in a single operation. This effectively extends the single-row double-entry concept and establishes a platform for table-based data entry.

Each table can feature multiple rows, each accommodating different bank transactions. The beauty of this system lies in the independence of each row from the others, allowing the contents of a transaction to be easily referenced by its corresponding row and column.

Data entry can occur either horizontally or vertically, manually or through copying and pasting from other sources, by filling in blank fields or selecting options from drop-down menus. This versatility streamlines the accounting process, eliminating the need to worry about the accounting jargons of debits and credits.

Upon saving, every row of transactions in the table is recorded as an independent standard double-entry voucher, and the entire set of transactions within the table can be saved simultaneously.

Invoice settlement occurs simultaneously with table entry. When entering account or customer information, the system offers helpful suggestions in a drop-down menu. After inputting this information, the system intelligently distinguishes between customer names and accounts, triggering a pop-up window displaying all relevant outstanding invoices associated with that specific account or customer.

When settling an invoice with a bank deposit, if the selected invoice amounts match the bank's deposited sum, the voucher is balanced, and the settlement is marked as complete, with the details recorded in the standard double-entry format.

In cases where the amounts do not align for any reason, such as short payments or discounts, an ‘settle’ icon will appear at the end of the voucher list, signaling that the voucher requires further attention and a follow up operation at a later time.

Upon settlement, a new page will display comprehensive information about the bank receipt and invoice. At the bottom of this page, a figure will indicate the total credit, debit, and the resulting difference. If the difference is non-zero, the cell will turn red, indicating the need for further adjustments. Once these adjustments are made, the cell will turn green, signifying that the voucher can be saved and recorded in the standard double-entry format.

### Second Embodiment

The Bank Transaction Table Entry Platform (BTEP) primarily focuses on recording bank transactions in a tabular format, with a specific emphasis on deposits and withdrawals, mirroring the structure of a typical bank statement. Further details about BTEP can be cross-referenced with the aforementioned first embodiment.

Table 11 illustrates both the upper and lower sections of the Bank Transaction Table Entry Platform (BTEP). In the upper section, you can find the list of recorded bank transactions, while the lower section is dedicated to adding new bank transactions to the table.

TABLE 11
bank dla
date [symbol] to [symbol] bank account [symbol] [symbol] [symbol]
search [symbol] edit [symbol] delete [symbol] bank

[symbol]

[symbol]

[symbol]

[symbol]

[symbol]

[symbol]

[symbol]

[symbol]

[symbol]

| | □ | voucher [symbol] | type | date [symbol] | [symbol] | [symbol] | [symbol] | [symbol] | amt (HKD) | accum bal | account |
|---|---|---|---|---|---|---|---|---|---|---|---|
| 1 | □ | [symbol] | B | 2623 Mar. 1 | HKD | | 1,000.00 | 1.0000 | −1,000.00 | 1,381.95 | xyz ltd |
| 2 | □ | [symbol] | B | 2023 Mar. 1 | HKD | | 66.00 | 1.0000 | −66.00 | 1,315.95 | bank charges |
| 3 | □ | [symbol] | B | 2023 Mar. 1 | HKD | | 500.00 | 1.0000 | −500.00 | 815.95 | bank charges |
| 4 | □ | [symbol] | B | 2023 Mar. 1 | HKD | 100.00 | | 1.0000 | 100.00 | 915.95 | auto add ltd |
| 5 | □ | [symbol] | B | 2023 Mar. 1 | HKD | 788.00 | | 1.0000 | 788.00 | 1,703.95 | abc ltd |
| 6 | □ | [symbol] | B | 2023 Mar. 4 | HKD | 1,200.00 | | 1.0000 | 1,200.00 | 2,903.95 | abc ltd |
| 7 | □ | [symbol] | B | 2023 Mar. 4 | HKD | 100.00 | | 1.0000 | 100.00 | 3,003.95 | abc ltd |
| 8 | □ | [symbol] | B | 2823 Mar. 4 | HKD | [symbol] 00.00 | | 1.0000 | [symbol] 00.00 | 3,303.95 | abc ltd |
| 9 | □ | [symbol] | B | 2023 Mar. 5 | HKD | 1,200.00 | | 1.0000 | 1,200.00 | 4,503.95 | abc ltd |
| 10 | □ | [symbol] | B | 2023 Mar. 6 | HKD | | 300.00 | 1.0000 | −300.00 | 4,203.95 | electricity & [symbol] |
| 11 | □ | [symbol] | B | 2023 Mar. 7 | HKD | | 500.00 | 1.0000 | −500.00 | 3,703.95 | cleaning |
| 12 | □ | [symbol] | B | 2023 Mar. 8 | HKD | 600.00 | | 1.0000 | 600.00 | 4,303.95 | def ltd |
| 13 | □ | [symbol] | B | 2023 Mar. 10 | HKD | | 800.00 | 1.0000 | −800.00 | 3,503.95 | xyz ltd |

date [symbol] to [symbol] bank account

[symbol]

[symbol]

| | [symbol] search [symbol] edit [symbol] delete [symbol] bank [symbol] [symbol] [symbol] [symbol] [symbol] [symbol] [symbol] [symbol] [symbol] | | | | |
|---|---|---|---|---|---|
| [symbol] search [symbol] edit [symbol] delete [symbol] bank [symbol] [symbol] [symbol] [symbol] [symbol] [symbol] [symbol] [symbol] [symbol] | desc | att | check # | | present date |
| 1 | check [symbol] | | | settle | |
| 2 | bank charg [symbol] | | | | 2023 Mar. 1 |
| 3 | bank charg [symbol] | | | | 2023 Mar. 1 |
| 4 | test 4 | | | settle | 2023 Mar. 1 |
| 5 | bank charg [symbol] | | | settle | 2023 Mar. 1 |
| 6 | test 3 | | | settle | 2023 Mar. 4 |
| 7 | test 2 | | | settle | 2023 Mar. 4 |
| 8 | test 1 | | | settle | 2023 Mar. 4 |
| 9 | [symbol] paymen [symbol] | | | settle | |
| 10 | | | 342651 | | |
| 11 | apr fee | | 342652 | | |
| 12 | [symbol] paymen [symbol] | | | settle | |
| 13 | bill paymen [symbol] | | 642653 | settle | |

| | | | | | | | |
|---|---|---|---|---|---|---|---|
| total: | opening | [symbol] | [symbol] | [symbol] | [symbol] | [symbol] | [symbol] |

[symbol]

[symbol]

[symbol]

new [symbol] customer [symbol] desc

| | | | | | | | | | | |
|---|---|---|---|---|---|---|---|---|---|---|
| yyyy/mm | dd | bank | cur | deposit | withdrawl | [symbol] rate | local amt | account/customer | invoice | desc |

| | | | | | | |
|---|---|---|---|---|---|---|
| 1 | 2023/ [symbol] | [symbol] | HKD | [symbol] | 1.0000 | [symbol] |
| 2 | | [symbol] | | [symbol] | | [symbol] |
| 3 | | [symbol] | | [symbol] | | [symbol] |
| 4 | | [symbol] | | [symbol] | | [symbol] |
| 5 | | [symbol] | | [symbol] | | [symbol] |
| 6 | | [symbol] | | [symbol] | | [symbol] |
| 7 | | [symbol] | | [symbol] | | [symbol] |

[symbol]

indicates data missing or illegible when filed

Conversely, the Bank Feed Platform (BFP) serves as a platform that supports bank feed functionalities offered by financial institutions. It facilitates the seamless import of bank transactions into BFP for the purpose of bank reconciliation. Moreover, it enables the generation of reports for unpresented checks. Additionally, if the bank feed data is of sufficient quality, BFP can automate the accounting entry process within the platform.

Table 12 provides a visual representation of the Bank Feed Platform (BFP), with its upper and lower sections. The upper section displays the list of reconciled bank feed transactions, while the lower section functions as a repository for imported bank transactions from the financial institution, with updates occurring at intervals of several hours or once per day.

TABLE 12
date 2023 Mar. 1 to 2023 Mar. 31 bank account bank c/a
search bank feed Feed start date & op bal 2023 Mar. 1-2381.95

| | present date | dr | cr | bal | desc | entry date |
|---|---|---|---|---|---|---|
| 1 | 2023 Mar. 4 | 300.00 | | 2,681.95 | test 1 | 2023 Mar. 4 |
| 2 | 2023 Mar. 4 | 100.00 | | 2,781.95 | test 2 | 2023 Mar. 4 |
| 3 | 2023 Mar. 4 | 1,200.00 | | 3,981.95 | test 3 | 2023 Mar. 4 |
| 4 | 2023 Mar. 1 | 100.00 | | 4,081.95 | test 4 | 2023 Mar. 1 |
| 5 | 2023 Mar. 1 | 788.00 | | 4,869.95 | bank charge | 2023 Mar. 1 |
| 6 | 2023 Mar. 1 | | 500.00 | 4,369.95 | bank charge | 2023 Mar. 1 |
| 7 | 2023 Mar. 1 | | 66.00 | 4,303.95 | bank charge | 2023 Mar. 1 |

period start date 2023 Mar. 1 [symbol] match-run [symbol] import

| | date | dr | cr | desc |
|---|---|---|---|---|
| 1 | 2023 Mar. 6 | 1,200.00 | | inv receipt 1 |
| 2 | 2023 Mar. 7 | 600.00 | | inv receipt 2 |
| 3 | 2023 Mar. 8 | | 300.00 | electricity 342651 |
| 4 | 2023 Mar. 9 | | 1,000.00 | xyz ltd |
| 5 | 2023 Mar. 9 | | 20.00 | bank charges |

Bank reconciliation is the procedure of comparing and aligning transaction data from a company's bank statements with the data in its accounting records, aiming to ensure the precision of financial information. Traditionally, this task has been executed manually, a method that is both time-consuming and prone to errors.

The Bank Feed Platform automates the reconciliation of the BTEP list and the BFP list, representing the company's accounting records and bank statements, respectively, to automatically achieve matching results.

This reconciliation process can be initiated using the following five buttons (Match-Run, Match-Save, Match Y/N, Create & Return) available within both BFP and the Reconciliation window. These buttons streamline the reconciliation process, encompassing the following steps:

### Reconciliation Process

1. Matching Transactions by date complement: Aligning transactions based on matching dates.
2. Editing Reconciled Transactions: Modifying reconciled transactions using the Match Y/N and Match-Save buttons.
3. Adding Unreconciled Transactions: Incorporating unreconciled transactions into BTEP using the Create button.
4. Generating Unpresented Check Report: Producing a report that highlights unpresented checks.

Table 13 showcases the Reconciliation Platform, providing a visual representation of the reconciliation process. In this table, the upper section contains the BTEP list, while the lower section displays the BFP list.

TABLE 13
btep list

| | voucher | type | date | cur | dr | cr | account | desc | check # | present date |
|---|---|---|---|---|---|---|---|---|---|---|
| 1 | [symbol] | B | 2023 Mar. 1 | HKD | | 1,000.00 | xyz ltd | check [symbol] | | |
| 2 | [symbol] | B | 2023 Mar. 5 | HKD | 1,200.00 | | abc ltd | [symbol] payment | | [symbol] |
| 3 | [symbol] | B | 2023 Mar. 6 | HKD | | 300.00 | electricity & water | | 342651 | [symbol] |
| 4 | [symbol] | B | 2023 Mar. 7 | HKD | | 500.00 | cleaning | [symbol] | 342652 | |
| 5 | [symbol] | B | 2023 Mar. 8 | HKD | 600.00 | | def ltd | [symbol] payment | | [symbol] |
| 6 | [symbol] | B | 2023 Mar. 10 | HKD | | 800.00 | xyz ltd | bill payment | [symbol] | |

btp list

| [symbol] return | | date | [symbol] | | [symbol] | entry date | match |
|---|---|---|---|---|---|---|---|
| 1 | □ | 2023 [symbol] | 1,200.00 | | inv receipt 1 | [symbol] | [symbol] |
| 2 | □ | 2023 [symbol] | 600.00 | | inv receipt 2 | [symbol] | [symbol] |
| 3 | □ | 2023 [symbol] | | [symbol] 00.00 | electricity 342651 | [symbol] | [symbol] |
| 4 | □ | 2023 [symbol] | | [symbol] .00 | bank charges | | [symbol] |
| 5 | □ | 2023 [symbol] | | [symbol] 000.00 | xyz ltd | | [symbol] |

[symbol]

indicates data missing or illegible when filed

The initiation of the reconciliation process begins with a simple click on the “Match-Run” button. This action triggers a pop-up window named the Reconciliation window, where the results of the matching process become visible in both the BTEP list and the BFP list.

The reconciliation technique involves meticulously pairing transactions based on similarities in amount and proximity of their respective dates. These matched transactions are then labeled with a date complement.

The results manifest in both lists, revealing both reconciled and unreconciled transactions. For reconciled entries, the date of the transaction in the BTEP list appears in the ‘Entry Date’ column of the BFP list, while the date from the corresponding transaction in the BFP list is mirrored in the ‘Present Date’ column of the BTEP list, forming a date complement to signify their reconciliation.

Conversely, unreconciled transactions appear with blank entries in both the ‘Entry Date’ and ‘Present Date’ columns, as clearly depicted in Table 13.

Users have the flexibility to review paired transactions for accuracy and make any necessary adjustments. When satisfied with the correctness of the pairings, users can simply click the “Match-Save” button. Transactions with completed ‘Entry Date’ columns are then officially recognized as reconciled transactions and are securely saved in the upper section of the BFP as illustrated in Table 12.

If an error is detected, users have the option to unmatch the erroneous transaction by clicking the “Y” button and switching it to “N,” as exemplified in Table 14. This action effectively clears the date complement, returning it to a blank state, and the transaction becomes available for a new match.

Users have the option to manually reconcile transactions one by one by selecting the “N” button for the desired transaction. For instance, consider the example below: a credit of HKD 1000 to XYZ Ltd in the BFP. as shown in Table 15.

TABLE 15

| btep | | | | | | | | | | present |
|---|---|---|---|---|---|---|---|---|---|---|
| list | voucher | type | date [symbol] | | dr | | criaccount | dese | check # | date |
| 1 | P-at23030001 | B | 2023 Mar. 1 | HKD | | 1,000.00 | xyz ltd | check unpre | | |
| 2 | R-at23030006 | B | 2023 Mar. 5 | HKD | 1,200.00 | | abc ltd | inv payment | | 2023 Mar. 6 |
| 3 | P-at23030004 | B | 2023 Mar. 6 | HKD | | 300.00 | electricity & | | 342651 | 2023 Mar. 8 |
| | | | | | | | water | | | |
| 4 | P-at23030005 | B | 2023 Mar. 7 | HKD | | 500.00 | cleaning | apr fee | 342652 | |
| 5 | R-a123030007 | B | 2023 Mar. 8 | HKD | 600.00 | | def ltd | inv payment | | 2023 Mar. 7 |
| 6 | P-at23030006 | B | 2023 Mar. 10 | HKD | | 800.00 | xyz ltd | bill payment | 642653 | |

bank feed
#Z,80 return#,81; match-save [symbol] create

| | | date [symbol] | dr | cr | desc: | entry date | match |
|---|---|---|---|---|---|---|---|
| 1 | □ | 2023 Mar. 6 | 1,200.00 | | inv receipt 1 | 2023 Mar. 5 | [symbol] |
| 2 | □ | 2023 Mar. 7 | 600.00 | | inv receipt 2 | 2023 Mar. 8 | [symbol] |
| 3 | □ | 2023 Mar. 8 | | 300.00 | electricity 342651 | 2023 Mar. 6 | [symbol] |
| 4 | □ | 2023 Mar. 9 | | 20.00 | bank charges | | [symbol] |
| 5 | □ | 2023 Mar. 9 | | 1,000.00 | xyz ltd | | [symbol] |

[symbol]

indicates data missing or illegible when filed

Upon clicking, a new window will appear, presenting a list of unreconciled transactions for user selection, as demonstrated in Table 16.

TABLE 16
swlect match
✓ confirm X cancel

| | | | | | | | |
|---|---|---|---|---|---|---|---|
| voucher | type | date [symbol] | cur | dr | er account | desc | check # |

| | | | | | | | | | |
|---|---|---|---|---|---|---|---|---|---|
| 1 | □ | P-at23030001 | B | 2023 Mar. 1 | HKD | 1,000.00 | xyz ltd | check unpre | |
| 2 | □ | P-at23030005 | B | 2023 Mar. 7 | HKD | 500.00 | cleaning | apr fee | 342652 |
| 3 | □ | P-at23030006 | B | 2023 Mar. 10 | HKD | 800.00 | xyz ltd | bill payment | 642653 |

[symbol]

indicates data missing or illegible when filed

Once the appropriate pairing is chosen, the transaction will be accurately re-entered with the corresponding “date complement,” as depicted in Table 17.

TABLE 17
btep list

| | | | | | | | | | | present |
|---|---|---|---|---|---|---|---|---|---|---|
| | voucher | type | date [symbol] | cur | dr | er | account | [symbol] | check # | date |
| 1 | P-at23030001 | B | 2023 Mar. 1 | HKD | | 1,000.00 | xyz ltd | check [symbol] | | 2023 Mar. 9 |
| 2 | R-at23030006 | B | 2023 Mar. 5 | HKD | 1,200.00 | | abc ltd | mv payment | | 2023 Mar. 6 |
| 3 | P-at23030004 | B | 2023 Mar. 6 | HKD | | 300.00 | electricity & water | | 342651 | 2023 Mar. 8 |
| 4 | P-at23030005 | B | 2023 Mar. 7 | HKD | | 500.00 | cleaning | apr fee | 342652 | |
| 5 | R-at23030007 | B | 2023 Mar. 8 | HKD | 600.00 | | def ltd | inv payment | | 2023 Mar. 7 |
| 6 | P-at23030006 | B | 2023 Mar. 10 | HKD | | 800.00 | xyz ltd | bill payment | 642653 | |

btp list
#Z,85 return [symbol] match-save [symbol] create

| | | date [symbol] | dr | cr | desc | entry date | match |
|---|---|---|---|---|---|---|---|
| 1 | □ | 2023 Mar. 6 | 1,200.00 | | my receipt 1 | 2023 Mar. 5 | [symbol] |
| 2 | □ | 2023 Mar. 7 | 600.00 | | inv receipt 2 | 2023 Mar. 8 | [symbol] |
| 3 | □ | 2023 Mar. 8 | | 300.00 | electricity 342651 | 2023 Mar. 6 | [symbol] |
| 4 | □ | 2023 Mar. 9 | | 20.00 | bank charges | | [symbol] |
| 5 | [symbol] | 2023 Mar. 9 | | 1,000.00 | xyz ltd | 2023 Mar. 1 | [symbol] |

[symbol]

indicates data missing or illegible when filed

Users can effortlessly retain all correctly paired transactions by simply clicking the “Match-Save” button, resulting in the preservation of all reconciled transactions in the upper section of the BFP, as seen in Table 18.

TABLE 18
date 2023 Mar. 1 [symbol] to 2023 Mar. 31 [symbol] bank account bank c/a [symbol] [symbol]
search bank feed Feed start date & op bal 2023 Mar. 1

[symbol]

[symbol]

| | present date [symbol] | dr | cr | bal | desc | entry date |
|---|---|---|---|---|---|---|
| 1 | 2023 Mar. 9 | | 1,000.00 | 1,381.95 | xyz ltd | 2023 Mar. 1 |
| 2 | 2023 Mar. 1 | 100.00 | | 1,481.95 | test 4 | 2023 Mar. 1 |
| 3 | 2023 Mar. 1 | 788.00 | | 2,269.95 | bank charge | 2023 Mar. 1 |
| 4 | 2023 Mar. 1 | | 500.00 | 1,769.95 | bank charge | 2023 Mar. 1 |
| 5 | 2023 Mar. 1 | | 66.00 | 1,703.95 | bank charge | 2023 Mar. 1 |
| 6 | 2023 Mar. 4 | 300.00 | | 2,003.95 | test 1 | 2023 Mar. 4 |
| 7 | 2023 Mar. 4 | 100.00 | | 2,103.95 | test 2 | 2023 Mar. 4 |
| 8 | 2023 Mar. 4 | 1,200.00 | | 3303.95 | test 3 | 2023 Mar. 4 |
| 9 | 2023 Mar. 6 | 1,200.00 | | 4503.95 | inv receipt 1 | 2023 Mar. 5 |
| 10 | 2023 Mar. 8 | | 300.00 | 4203.95 | electricity 342651 | 2023 Mar. 6 |
| 11 | 2023 Mar. 7 | 600.00 | | 4803.95 | inv receipt 2 | 2023 Mar. 8 |

period start date 2023 Mar. 1 [symbol] [symbol] match-run [symbol] import

[symbol]

| | date | dr | cr | desc |
|---|---|---|---|---|
| 1 | 2023 Mar. 9 | | 20.00 | bank charges |

[symbol]

indicates data missing or illegible when filed

To address any unreconciled transactions located in the lower section of the BFP, users can either create individual or multiple transactions by selecting the appropriate transactions and activating the Create button as demonstrated in Table 19.

TABLE 19
btep list

| | voucher | type | date [symbol] | cur | dr | cr | account | desc | check # | present date |
|---|---|---|---|---|---|---|---|---|---|---|
| 1 | [symbol] | B | 2023 Mar. 7 | HKD | | 500.00 | cleaning | apr fee | 342652 | |
| 2 | [symbol] | B | 2023 Mar. 10 | HKD | | 800.00 | xyz ltd | bill payment | 642653 | |

btep list [symbol]
return [symbol] match-save [symbol] create

| | | present date [symbol] | dr | cr | desc | entry date | match |
|---|---|---|---|---|---|---|---|
| 1 | □ | 2023 Mar. 9 | | 20.00 | bank charges | | [symbol] |

[symbol]

indicates data missing or illegible when filed

Upon activation, the system will automatically fill in some of the information in the NEW section of the BTEP bottom window as exemplified in Table 20 and users can then add the remaining information and click the Save button to record the transactions as illustrated in Table 21. Once created, the BFP section should have no unreconciled transactions remaining, ensuring a tidy and complete record.

TABLE 20 [symbol]
save [symbol] [symbol] new [symbol] customer [symbol] desc

| | | | | | | | | | | |
|---|---|---|---|---|---|---|---|---|---|---|
| yyyy/mm | dd | bank | our | deposit | withdrawl | ex [symbol] rate | local amt | account/customer | invoice | desc |

| | | | | | | | | |
|---|---|---|---|---|---|---|---|---|
| 1 | 2023/03 | 9 | [symbol] | [symbol] | 20 | [symbol] | bank charges | [symbol] |
| 2 | | | [symbol] | [symbol] | | [symbol] | | [symbol] |
| 3 | | | [symbol] | [symbol] | | [symbol] | | [symbol] |
| 4 | | | [symbol] | [symbol] | | [symbol] | | [symbol] |
| 5 | | | [symbol] | [symbol] | | [symbol] | | [symbol] |

[symbol]

indicates data missing or illegible when filed

TABLE 21
btep list

| | voucher | type | date [symbol] | cur | dr | cr | account | desc | check # | present date [symbol] |
|---|---|---|---|---|---|---|---|---|---|---|
| 1 | [symbol] | B | 2023 Mar. 7 | HKD | | 500.00 | cleaning | apr fee | 342652 | |
| 2 | [symbol] | B | 2023 Mar. 9 | HKD | | 20.00 | bank charges | bank charges | | 2023 Mar. 9 |
| 3 | [symbol] | B | 2023 Mar. 10 | HKD | | 800.00 | xyz ltd | bill payment | 642653 | |

bfp list [symbol]
return [symbol] match-save [symbol] create

| | | present date [symbol] | dr | cr | desc | entry date | match |
|---|---|---|---|---|---|---|---|
| 1 | □ | 2023 Mar. 9 | | 20.00 | bank charges | 2023 Mar. 9 | [symbol] |

[symbol]

indicates data missing or illegible when filed

This feature not only helps with bank reconciliation but also facilitates data entry for all bank transactions, streamlining daily accounting tasks for users with limited accounting experience.

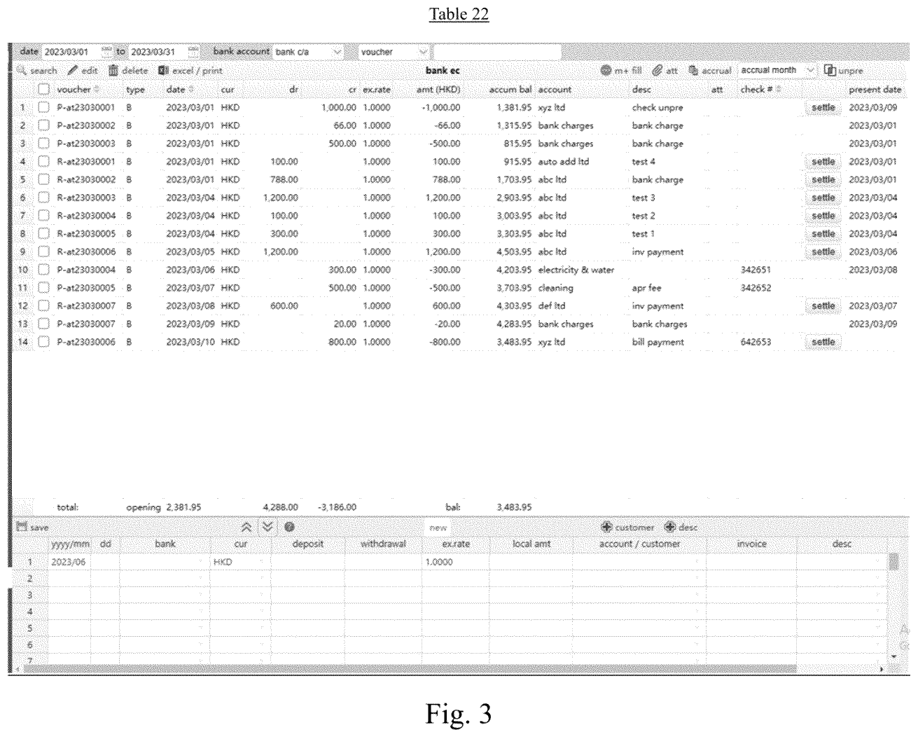

After all transactions in BFP list been reconciled, If there are still unreconciled transactions in the BTEP list, they are considered unpresented transactions as illustrated in Table 22 (FIG. 3).

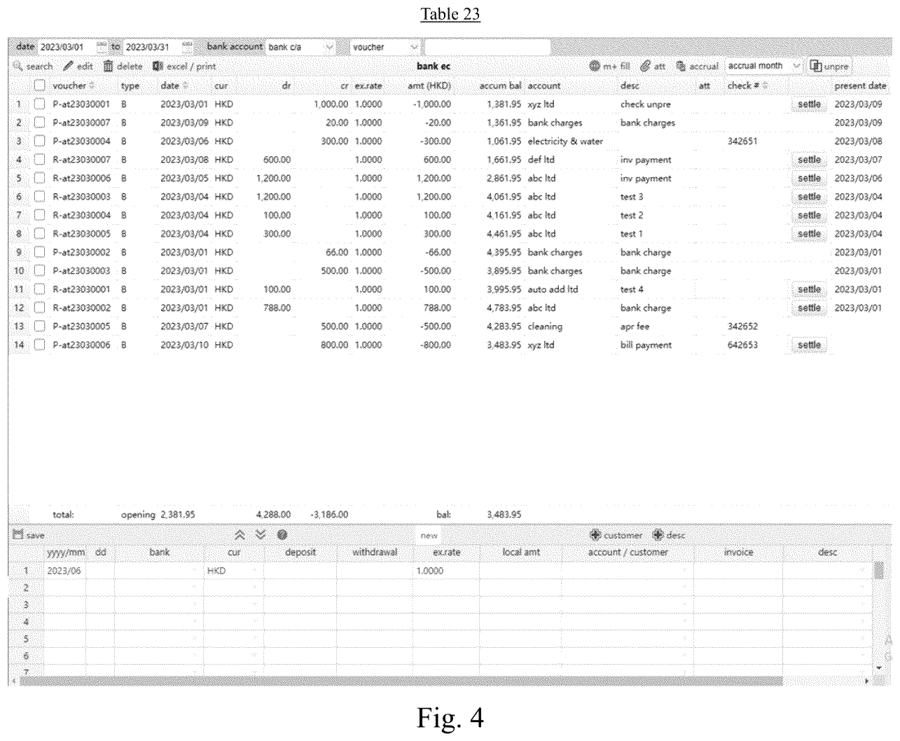

By selecting the “Unpre” button within the BTEP list, all unreconciled transactions will be displayed at the bottom, featuring a column labeled ‘Present Date’ that remains unfilled, as depicted in Table 23 (FIG. 4). These transactions can be identified as unpresented transactions.

### Feed Start Date & Balance

By adding the figures of the Feed start date and balance at the right top corner of the BFP as illustrated in Table 24, this time the start date is March 1 and the start balance is hkd2381.95 which is the same as the op balance of the BTEP. Then the final balance of the BFP is hkd4783.95 which is matched with the accumulative bank balance after all reconciled transactions but before the unreconciled transactions as illustrated in Table 23. The matching of these two figures can be regarded as the evident to the correctness of the bank feed process as well as the bank reconciliation.

### Period Start Date

The Period start date is to control the date of transaction shown in the BTEP, all transactions before the period start date will not be included in the list for matching process as illustrated in the Table 24.

With the help of the Feed Start date and Period Start date, the Bank Feed and reconciliation function can be applied at any time in the middle of the accounting, no need to work out from the beginning of the accounting period.

TABLE 24
date 2023 Mar. 1 [symbol] to 2023 Mar. 31 [symbol] bank account bank c/a [symbol] [symbol]
search bank feed Feed start date & op bal 2023 Mar. 1

[symbol]

[symbol]

| | present date [symbol] | dr | cr | bal | desc | entry date |
|---|---|---|---|---|---|---|
| 1 | 2023 Mar. 6 | 1,200.00 | | 3,581.95 | inv receipt 1 | 2023 Mar. 5 |
| 2 | 2023 Mar. 7 | 600.00 | | 4,181.95 | inv receipt 2 | 2023 Mar. 8 |
| 3 | 2023 Mar. 8 | | 300.00 | 3,881.95 | electricity 342651 | 2023 Mar. 6 |
| 4 | 2023 Mar. 9 | | 1,000.00 | 2,881.95 | xyz ltd | 2023 Mar. 1 |
| 5 | 2023 Mar. 9 | | 20.00 | 2,861.95 | bank charge | 2023 Mar. 9 |
| 6 | 2023 Mar. 4 | 300.00 | | 3,161.95 | test 1 | 2023 Mar. 4 |
| 7 | 2023 Mar. 4 | 100.00 | | 3,261.95 | test 2 | 2023 Mar. 4 |
| 8 | 2023 Mar. 4 | 1,200.00 | | 4,461.95 | test 3 | 2023 Mar. 4 |
| 9 | 2023 Mar. 1 | 100.00 | | 4,561.95 | test 4 | 2023 Mar. 1 |
| 10 | 2023 Mar. 1 | 788.00 | | 5,349.95 | bank charge | 2023 Mar. 1 |
| 11 | 2023 Mar. 1 | | 500.00 | 4,849.95 | bank charge | 2023 Mar. 1 |
| 12 | 2023 Mar. 1 | | 66.00 | 4,783.95 | bank charge | 2023 Mar. 1 |

| period start date 2023 Mar. 1 [symbol] [symbol] match-run [symbol] import [symbol] | | | |
|---|---|---|---|
| date | dr | cr | desc |

[symbol]

indicates data missing or illegible when filed

The unreconciled transactions will be carried forward to the next reconciliation with the BFP. As the bank feed function updates regularly, users can opt to reconcile transactions at a later time when all relevant transactions have been imported.

### Third Embodiment

### Auto Accounting Entry

In the chapter introducing BTEP, there is a mention of one of BTEP's features that can serve as the foundation for future accounting automation development BTEP's extended feature, BFP, has a scheduled automatic bank transaction import function. If the data within includes payer/payee information, it can use machine learning to automatically assign them to the appropriate account. In this way, the manual creation function of BFP can be expanded to automatically complete the accounting process, achieving to Auto Accounting Entry.

The data imported through the bank feed includes information similar to a bank statement, such as date, amount, income or expense designation, currency, and more. Some statements contain payer/payee data, while others do not. When payer/payee data is available, during the addition of a bank transaction, one of the crucial columns, “customer/account,” can be populated with the payer/payee information for that transaction. Through machine learning, this information can be matched with the appropriate account. It is used to formalize admin expenses into an official admin voucher. Simultaneously, it is employed in customer and supplier settle vouchers, enabling the completion of the payment or receipt voucher portion while keeping the settlement of invoice portion for later processing.

With this mechanism in place, bank transactions can go from the bank feed to completed vouchers automatically, without any manual intervention. What remains to be done is confirming the correctness of bank transactions and supplementing invoice numbers by pressing the ‘settle’ button. These two steps require the USER to complete them.

With this automated accounting function in place, it's possible to take it a step further by not pre-creating accounting entries at all. Instead, let the bank feed bring in the transaction data and use the ‘auto create’ feature to automatically complete the accounting process.

Such automated accounting eliminates the need for accounting knowledge or debit/credit understanding in the operational process. This significantly reduces the knowledge requirements for accounting while simultaneously greatly enhancing efficiency in accounting processes.

Here is an illustration of how the auto accounting entry works with a real example and visuals:

FIG. 25 - BFP

| date | | bank account | | feed start date & op bal | | | |
|---|---|---|---|---|---|---|---|
| search | date | dr | cr | bal | payer/payee | desc | entry date |
| 1 | | | | | | | |
| 2 | | | | | | | |
| 3 | | | | | | | |
| 4 | | | | | | | |
| 5 | | | | | | | |
| 6 | | | | | | | |
| 7 | | | | | | | |
| 8 | | | | | | | |
| 9 | | | | | | | |

| period start date | | | match-run | | | | |
|---|---|---|---|---|---|---|---|
| | date | dr | cr | | import | payer/payee | desc |
| 1 | Mar. 6, 2023 | 1200 | | | | abc ltd | |
| 2 | Mar. 7, 2023 | 600 | | | | def ltd | |
| 3 | Mar. 8, 2023 | | | 300 | | govemment | |
| 4 | Mar. 9, 2023 | | | 1000 | | xyz ltd | |
| 5 | Mar. 9, 2023 | | | 20 | | bank charge | |
| 6 | | | | | | | |
| 7 | | | | | | | |
| 8 | | | | | | | |

Table 25 demonstrated the BPP, you can see bank transactions imported from the bank feed, some of which contain payer/payee information. When you click on the “match-run” button, the system performs an automatic matching process.

TABLE 26
Reconciliation Window
BTEP list

| | voucher | type | date | cur | dr | cr | account | desc | att | check # | present date |
|---|---|---|---|---|---|---|---|---|---|---|---|
| 1 | | | | | | | | | | | |
| 2 | | | | | | | | | | | |
| 3 | | | | | | | | | | | |
| 6 | | | | | | | | | | | |
| 7 | | | | | | | | | | | |
| 8 | | | | | | | | | | | |
| 9 | | | | | | | | | | | |

| BFP list | | | | | | | |
|---|---|---|---|---|---|---|---|
| | match-save | create | autocreate | | | | |
| return | date | dr | [symbol] | payer/payee | desc | entry date | match |
| 1 | Mar. 6, 2023 | 1200 | | abc ltd | | | n |
| 2 | Mar. 7, 2023 | 600 | | def ltd | | | n |
| 3 | Mar. 8, 2023 | | 300 | government | | | n |
| 4 | Mar. 9, 2023 | | 1000 | xyz ltd | | | n |
| 5 | Mar. 9, 2023 | | 20 | bank charge | | | n |
| 6 | | | | | | | |
| 7 | | | | | | | |
| 8 | | | | | | | |

[symbol]

indicates data missing or illegible when filed

Table 26 demonstrated the Reconciliation Window, the user has not yet created accounting entries, so there are no pending bank transactions to match in the upper section. In the lower section, the matching results in the “match” column all display “n,” indicating no successful matches.

At this point, when you click on ‘auto create,’ based on the available payer/payee data, the system has enough information to automatically generate four vouchers in BTEP, as illustrated in the upper part of the Table 27. These vouchers have a formal double-entry format, with the date and present date being the same. Among them, the settle vouchers are flagged with ‘settle’ for later processing.

TABLE 27
Reconciliation Window
BTEP list

| | voucher | type | date | cur | dr | cr | account | desc | att | check # | present date |
|---|---|---|---|---|---|---|---|---|---|---|---|
| 1 | R-2303001 | | Mar. 6, 2023 | | 1200 | | abc ltd | | | | Mar. 6, 2023 |
| 2 | P-2303001 | | Mar. 8, 2023 | | | 300 | government | | | | Mar. 8, 2023 |
| 3 | P-2303002 | | Mar. 9, 2023 | | | 1000 | xyz ltd | | | | Mar. 9, 2023 |
| 4 | P-2303003 | | Mar. 9, 2023 | | | 20 | bank charge | | | | Mar. 9, 2023 |
| 5 | | | | | | | | | | | |
| 6 | | | | | | | | | | | |
| 7 | | | | | | | | | | | |
| 8 | | | | | | | | | | | |
| 9 | | | | | | | | | | | |

BFP list

| | match-save | create | auto create | | | | |
|---|---|---|---|---|---|---|---|
| return | date | dr | cr | payer/payee | desc | entry date | match |
| 1 | Mar. 7, 2023 | 600 | | def ltd | | | n |
| 2 | | | | | | | |
| 3 | | | | | | | |
| 4 | | | | | | | |
| 5 | | | | | | | |
| 6 | | | | | | | |
| 7 | | | | | | | |
| 8 | | | | | | | |

These four vouchers are also updated in BFP, as seen in the upper part of the Table 27, effectively completing the bank reconciliation, matching with the bank statement. However, there is one payer, “def ltd,” for which the system lacks customer registration information, resulting in insufficient conditions for successful auto creation. This entry will remain in the lower section until you complete the registration of the customer “edf ltd” and then reprocess it.

TABLE 28
BFP

| date | | bank account | | feed start date & op bal | | | |
|---|---|---|---|---|---|---|---|
| search | date | dr | cr | bal | payer/payee | desc | entry date |
| 1 | Mar. 6, 2023 | 1200 | | | abc ltd | | Mar. 6, 2023 |
| 2 | Mar. 8, 2023 | | 300 | | government | | Mar. 8, 2023 |
| 3 | Mar. 9, 2023 | | 1000 | | xyz Itd | | Mar. 9, 2023 |
| 4 | Mar. 9, 2023 | | 20 | | bank charge | | Mar. 9, 2023 |
| 5 | | | | | | | |
| 6 | | | | | | | |
| 7 | | | | | | | |
| 8 | | | | | | | |
| 9 | | | | | | | |

| period start date | | | match-run | | | |
|---|---|---|---|---|---|---|
| | date | dr | cr | import | payer/pay [symbol] | desc |
| 1 | | | | | | |
| 2 | | | | | | |
| 3 | | | | | | |
| 4 | | | | | | |
| 5 | | | | | | |
| 6 | | | | | | |
| 7 | | | | | | |
| 8 | | | | | | |

[symbol]

indicates data missing or illegible when filed

In summary, both BTEP and BFP offer advantages that simplify and enhance various aspects of accounting and financial management, from data entry and reconciliation to reporting and automation. These platforms collectively contribute to more efficient and accurate financial processes, benefiting users with varying levels of accounting knowledge and experience.

It will be apparent to those skilled in the art that the present application is not limited to the details of the above exemplary embodiments, and that the present application can be implemented in other specific forms without departing from the spirit or basic features of the present application. Therefore, from any point of view, the embodiment should be regarded as exemplary and unrestricted, and the scope of the present application is limited by the appended claims rather than the above description, so it is intended to include all changes within the meaning and scope of the equivalent elements of the claims in the present application. Any reference sign in the claims shall not be deemed to limit the claims to which it relates.

What is claimed is:

1. A bank transaction recording system comprising:
a table entry platform configured to receive bank transaction data in a single-row format, said data including but not limited to date, bank account, currency, amount for debit or credit, the other account (account/customer), and description;
an automated voucher generation module configured to generate standard double-entry vouchers automatically from said data, said vouchers replicating the structure of a bank statement.

2. The bank transaction recording system of claim 1, wherein the table entry platform further comprises:
a table header that includes fields corresponding to the data input fields in the single-row format, said table header facilitating the accurate input of bank transaction data;
wherein the automated voucher generation module is further configured to categorize the generated vouchers based on the type of bank transaction, distinguishing between deposit and withdrawal vouchers.

3. The bank transaction recording system of claim 1, wherein the system allows for the simultaneous input of multiple bank transactions through a table format, wherein said multiple transactions are vertically arranged within the same column in the table entry platform.

4. The bank transaction recording system of claim 3, wherein the system further comprises a copy-and-paste feature, enabling the efficient replication of multiple transactions within the same column of the table entry platform.

5. The bank transaction recording system of claim 1, further comprising an invoice settlement feature, wherein the system differentiates between account names and customer names in the ‘account/customer’ column and automatically checks for outstanding invoices related to a specific customer when a customer's name is inputted.

6. The bank transaction recording system of claim 5, wherein, if the input bank transaction amount matches the total of selected invoices, the system automatically records the transaction in standard double-entry format, ensuring invoice settlement;
if the input bank transaction amount does not precisely match the total of selected invoices, the system generates a ‘settle’ notification, indicating an unaccounted balance, and provides a reconciliation feature for resolving the discrepancy.

7. A computer-implemented method, applied to the system according to claim 1, for automating bank reconciliation, comprising:
receiving bank transaction data from a Bank Transaction Table Entry Platform (BTEP);
receiving bank transaction data from a Bank Feed Platform (BFP);
automatically reconciling the received bank transaction data from BTEP and BFP based on similarities in amount and proximity of transaction dates;
labeling matched transactions with a date complement to signify their reconciliation.

8. The method of claim 7, further comprising:
displaying reconciled transactions with an ‘Entry Date’ in the BFP list;
displaying reconciled transactions with a corresponding ‘Present Date’ in the BTEP list;
identifying unreconciled transactions by blank entries in both the ‘Entry Date’ and ‘Present Date’ columns.

9. The method of claim 7, wherein reconciliation is initiated by clicking a “Match-Run” button, and the results are displayed in a pop-up Reconciliation window.

10. The method of claim 7, also for controlling the display of bank transactions, comprising:
receiving a Period Start Date input;
displaying bank transactions in the Bank Transaction Table Entry Platform (BTEP) based on the Period Start Date, excluding transactions before the specified date.

11. The method of claim 7, also for ensuring correctness in bank feed and reconciliation processes, comprising:
displaying Feed Start Date and Balance information;
automatically matching the final balance in the Bank Feed Platform (BFP) with the accumulated bank balance after reconciled transactions in the Bank Transaction Table Entry Platform (BTEP);
wherein the Feed Start Date and Balance information are used to verify the accuracy of the bank feed and reconciliation processes.

12. The method of claim 7, also for carrying forward unreconciled transactions for future reconciliation, comprising:
identifying unreconciled transactions in the Bank Transaction Table Entry Platform (BTEP);
carrying forward unreconciled transactions to the next reconciliation process with the Bank Feed Platform (BFP);
further comprising allowing users to reconcile transactions at a later time when all relevant transactions have been imported into the Bank Feed Platform (BFP).

13. The method of claim 7, also for Auto Accounting Entry, comprising:
a Bank Feed Platform (BFP) with a scheduled automatic bank transaction import function;
machine learning algorithms to automatically assign payer/payee information from bank transaction data to the appropriate accounts;
an automatic voucher generation feature that formalizes transactions into double-entry vouchers, with dates and present dates being the same;
the capability to differentiate and flag settle vouchers for later processing;
an ‘auto create’ feature to automatically complete the accounting process based on available payer/payee data, reducing the need for manual accounting entries;
the system's ability to enhance efficiency in accounting processes by simplifying the accounting workflow and reducing knowledge requirements.

14. The method of claim 7, comprising the following steps:
generating a bank transaction table, wherein the bank transaction table has an item column at the top, which contains at least the following items: deposit, associated with a revenue item, withdrawal, associated with an expenditure item, account, associated with a customer account; and
the bank transaction table further has a record column consistent with the item column, which is used to fill in a corresponding data record; and
obtaining transaction recording data and inputting the transaction recording data into the record column;
wherein the item column further comprises at least one or a combination of the following items:
voucher number, associated with a number of a transaction;
date, associated with a date of the transaction;
cur, associated with a currency of the transaction;
ex. rate, associated with an exchange rate; and
invoice, associated with a bill number associated with the transaction.

15. The method of claim 14, further comprising:
determining the data record filling status of the deposit item and the withdrawal item in the record column of the corresponding same row; and
if detecting that the record column of any one of the deposit item and the withdrawal item is filled with data, locking the record column of the other item.

16. The method of claim 7, further comprising allowing users to manually reconcile transactions by selecting and pairing unreconciled transactions one by one.

17. The method of claim 7, further comprising generating a report highlighting unpresented checks.

18. The method of claim 7, further comprising:
allowing users to review and adjust paired transactions for accuracy;
automatically saving correctly paired transactions upon user confirmation.

19. A computer program product stored on a non-transitory computer-readable medium, comprising instructions that, when executed by a processor, perform the method steps of claim 7.
